(19) United States
(12) Patent Application Publication
(10) Pub. No.: US 2011/0280660 A1
(43) Pub. Date: Nov. 17, 2011

(54) CHEMICAL SORBENT ARTICLE

(76) Inventors: Pradip Bahukudumbi, Greenville, SC (US); Patrick A. Petri, Greer, SC (US); Dale S. Kitchen, Boiling Springs, SC (US); Walter A. Scrivens, Moore, SC (US); Kirkland W. Vogt, Simpsonville, SC (US); David E. Wenstrup, Greer, SC (US); Hao Zhou, Boiling Springs, SC (US); Patrick R. Carroll, Spartanburg, SC (US)

(21) Appl. No.: 13/091,469

(22) Filed: Apr. 21, 2011

Related U.S. Application Data
(60) Provisional application No. 61/334,617, filed on May 14, 2010.
(60) Provisional application No. 61/348,192, filed on May 25, 2010.
(60) Provisional application No. 61/357,775, filed on Jun. 23, 2010.

(51) Int. Cl. E02B 15/04; B32B 5/26; D03D 15/00; D04G 1/00; D02G 3/00; D04H 13/00; D04B 21/00; B82Y 99/00

(52) U.S. Cl. 405/63; 442/327; 442/381; 442/304; 442/181; 442/1; 428/364; 977/700

(57) ABSTRACT

A chemical sorbent article comprising a nonwoven containing a plurality of thermoplastic nanofibers and a textile, where the textile at least partially surrounds the non-woven. Also an oil boom fence containing a nonwoven comprising a plurality of thermoplastic nanofibers, a weight, a buoyancy article, and a fabric. The fabric at least partially surrounds the nonwoven, the weight, and the buoyancy article and the weight and buoyancy article are separated by the nonwoven.

### RELATED APPLICATIONS

This application claims priority to provisional applications 61/334,617 filed May 14, 2010, 61/348,192 filed May 25, 2010, and 61/357,775 filed Jun. 23, 2010, all of which are herein incorporated by reference in their entirety.

### FIELD OF THE INVENTION

The present invention generally relates to articles used to clean up chemical spills by absorbing the spilled material.

### BACKGROUND

Chemical spills cause risks of bodily harm and environmental damage. Safe and efficient containment and clean up of these chemical spills is very important.

One such example is an oil spill. As oil is explored, transported, stored and used there is always a risk of spillage that could cause significant environmental damage.

As evidenced by the recent oil spills in Alaska and the Gulf of Mexico, there is an urgent need to improve techniques for protecting the environment from the spills. Efforts to mitigate the effects of offshore oil spills include chemical dispersion and the use of absorbent pads or powder. Chemicals are sometimes effective to disperse the oil into the water if applied shortly after the spill. However, it is not always possible to respond with dispatch because of a variety of reasons, such as the remote location of the spill, lack of chemicals, and weather. Moreover, the long term effects of many dispersants on the ecology have not been fully tested.

One method for cleaning oil spills is using cellulose-based materials such as wood pulp fibers because the low cost of wood pulp-based material makes them desirable. However, cellulose-based materials are hydrophilic and attractive to oil, or oleophilic, and therefore absorb both oil and water readily. Accordingly, when cellulose-based material is used to clean an oil spill in water, it tends to absorb both oil and water and thus a significant portion of the cellulose-based material becomes saturated with water or other aqueous solutions such as saline. This inhibits oil spill clean up and also makes reclamation of the absorbed oil quite challenging. Another method for cleaning oil spills is the use of meltblown polypropylene material applied as pads or booms. The meltblown material, which is made of micron-sized oleophilic fibers, typically absorbs only up to 15 times its dry weight, thereby limiting its overall performance. Thus, there is still a need for easily deployed sorbent articles with even higher sorbency of the chemicals they are designed to absorb than are currently available.

### BRIEF DESCRIPTION OF THE FIGURES

An embodiment of the present invention will now be described by way of example, with reference to the accompanying drawings.

FIGS. 1A-1C and B are schematic views of one embodiment of the sorbent article in a tear drop shape.

FIG. 2 is schematic view of a mat formed as the sorbent article.

FIG. 3 is schematic view of a mat formed as the sorbent article with a textile surrounding the mat.

FIG. 4 is a schematic view of one embodiment of the sorbent article having multiple lobes.

FIGS. 5 and 6 illustrate different shapes of the sorbent article.

FIGS. 7 and 8 illustrate a cross-sectional view of one embodiment of the oil boom fence.

### DETAILED DESCRIPTION

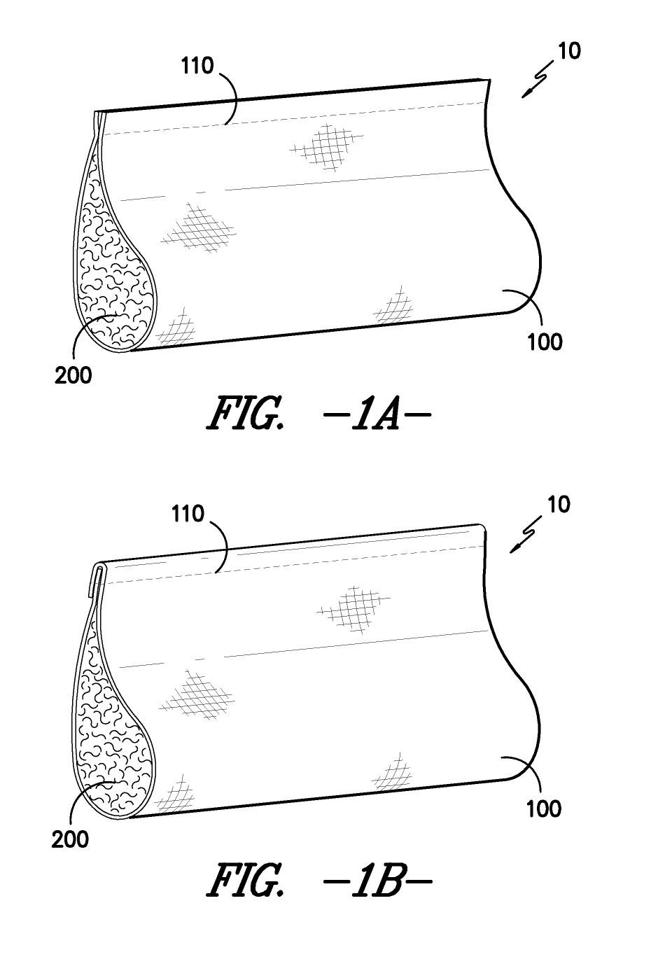

Referring now to FIG. 1, there is shown one embodiment of the chemical sorbent article 10 (also referred to as the sorbent article). The sorbent article contains a reinforcing textile 100 at least partially surrounding a nonwoven 200 made of thermoplastic nanofibers. A seam 110 encloses the textile 100 around the nonwoven 200.

The nonwoven 200 is made up of any suitable thermoplastic nanofibers. The nonwoven can be in the form of a collection of fibers, a mat, a batting, or any other suitable nonwoven configuration. The nanofibers have a diameter of less than about 1000 nm, more preferably less than about 800 nm, more preferably less than about 500 nm, more preferably less than about 300 nm, more preferably less than about 100 nm, more preferably less than about 70 nm. It has been found that using smaller diameter fibers (moving from >1 μm to <1 μm) increases the amount of chemical (spill) that can be absorbed by weight of the nanofiber nonwoven.

The nonwoven 200 preferably has a high loft, meaning that it has a relatively low density. In one embodiment, the density of the nonwoven 200 is preferably less than about 0.2 g/cm³, more preferably less than about 0.1 g/cm³, more preferably less than about 0.05 g/cm³. It is believed that the high loft in a nonwoven material allows for quicker penetration and better absorption of the spill. This has shown to be true in dirty motor oil in water. It is important to optimize the loft of the sorbent material and the pore size to balance the trade off between oil absorption and retention. Nanofibers have been found to allow the engineering of sorbent materials with high porosity without compromising oil retention.

The nanofibers are selected to optimize the performance based on the type of chemical spill and the environment of the spill. For example, in an oil spill in sea water, the nanofibers would preferably have low to no solubility in water and oil, be hydrophobic and oleophilic, and have a low density. These nanofibers would not dissolve in the sea water or oil, would absorb the oil well, and once filled or saturated with the oil, the nanofibers would remain at the surface of the ocean for easy removal. The characteristics of the polymer chosen for the nanofibers would be different for different spills such as an acid spill or alkali spill. For each spill, the polymer chosen would desirably not dissolve in the environment of the spill or in the spill itself and have an affinity for the spilled chemical.

Depending on the spill to be absorbed, the nanofibers, may be continuous or discontinuous blown fibers or staple. The fibers may have any suitable cross-section including but not limited to circular, elliptical, regular or irregular, tape, rectangular, and multi-lobal. A partial listing of polymers for use as the thermoplastic nanofiber include, but are not limited to, polyesters (e.g., polyethylene terephthalate (PET) or glycol-modified PET (PETG)), polyamides (e.g., nylon 6 or nylon 6,6), polyethylenes (e.g., high density polyethylene (HDPE) or linear low density polyethylene (LLDPE)), polypropylenes, polystyrene, polyethylene oxide (PEO), polylactic acid, poly(1,4-cyclohexanedimethylene terephthalate) (PCT), polytetrafluoroethylene (PTFE) and combinations thereof. Nanofibers also include, but are not limited to, bicomponent binder fibers (e.g., bicomponent binder fibers comprising a thermoplastic sheath) and thermoplastic binder fibers having a relatively low melt flow rate. The nanofibers in the nonwoven 200 may also have additives and/or coatings that enhance the performance of the nanofiber, such as nucleating agents, blooming additives to modify surface properties, UV stabilizers, antioxidants, anti bacterial agents, etc. The additives and coatings may increase the affinity of the nanofibers for the chemical spill and make them easier to handle before or after application to a spill.

In the case of an oil spill, the nanofibers are preferably oleophilic in nature, more preferably polypropylene. Polypropylene is preferable as it is hydrophobic, easy to process, inexpensive, has low density (of the polymer) and has been shown to absorb a high weight of oil per weight of fiber. Experiments have shown an ability of a polypropylene based nanofiber nonwoven to absorb at least 50 times it dry weight in oil. It should be emphasized that nanofiber nonwovens in this patent application refer to nonwoven mats wherein the majority of the fibers are less than 1 μm.

The nanofiber nonwoven 200 is characterized by very high surface area due to the small diameters of the individual fibers. The small fibers provide a high quantity of small pores and high amount of surface area for sorption of chemicals. Specifically, polypropylene (PP) fibers and other thermoplastic fibers can be oleophilic. In the case of oil or liquid hydrocarbons, the PP nanofiber web is very efficient at absorbing and trapping the hydrocarbons. The high surface area provides a large quantity of absorption sites and the small pore sizes help trap the liquid into very small volumes. This forms a gel-like substance when the nanofiber web has been saturated, which does not occur in larger fiber webs. Therefore, the retention capacity of a nanofiber web has been found to be higher than in a larger fiber mat (i.e. the liquid absorbed does not drain back out as it would in a larger fiber/larger pore structure). It should be pointed out that absorption and adsorption are often used interchangeably in the literature based on how they are defined. Herein, absorption generically to describe the physical processes (mechanical and chemical affinities) of oil capture and retention in a fibrous network.

In one embodiment, a blend of two or more size ranges of nanofibers may be used. FIG. 1C illustrates an embodiment where the sorbent article 10 contains both nanofibers 200 and micron sized fibers. The nanofibers in the blend provide superior oil absorption and retention while the micron sized fibers provide a lower cost point and a method for reusing polymer fiber waste streams. The rate of oil wicking into the fibrous sorbent can be tuned by optimizing the blend of fibers. The micron and nano fibers may be of the same polymer type or different and may have the same or different lengths. The nanofibers and micron-sized may be any suitable polymer type, for example the nanofibers may be polypropylene and the micon-sized fibers may be polypropylene, polyethylene, or polyester.

One example of micron-sized fibers are meltblown fibers. Meltblowing is a process of making fibrous webs, wherein high velocity air blows a molten thermoplastic polymer through a series of holes at the die tip onto a conveyor or take up screen to form a nonwoven web comprising 2-10 μm diameter fibers. In order to save cost, scrap waste generated during the meltblowing process is sent through a chopper gun to make short fibers that can then be used to fill booms for oil absorption.

Another example of micron-sized fibers are staple fibers which are traditionally used to make spun yarns or carded into nonwoven webs. The process used to make staple fibers consists of the following steps—Extrusion or spinning, drawing, crimping and packaging. Polypropylene staple fibers are usually between 15 and 40 μm in diameter and several inches long. In another embodiment, the micron-sized fibers are staple fibers in the form of “fiber clusters” or “fiber balls” as described in U.S. Pat. No. 6,613,431 can also be used as oil sorbents. The patent describes a modified carding machine that mechanically twists and entangles polyester fibers into fiber balls.

In one embodiment, the percentages of the fiber blend being nanofibers is between about 2 and 98%, more preferably about 10 and 90%, more preferably about 20 and 80%, more preferably about 30 and 70%, more preferably about 20 and 60%, more preferably about 30 and 50% with the remainder being micron-sized fibers. In one embodiment, the ratio by weight of the nanofiber to micron-sized fiber is between 20:80 and 80:20, more preferably between 30:70 and 65:35.

In one embodiment, the micron sized fibers have an antistat applied to the fibers, preferably in a range of between about 2 and 5% by weight of the micron fibers. The antistat serves to control the static electricity of the blend during blending and prevent clumping and melting of the blend.

An additional benefit of using staple fibers in the blend is that by using crimped and/or voluminous fibers the overall volume of the blend can be increased. These staple fibers allow for a pseudo web structure within the blend that offers a backbone of support to keep the nanofibers well distributed and the nanofiber surfaces well exposed. The addition of these staple fibers, especially those with crimp and/or other voluminous characteristics, allows for the blend to be packaged by traditional methods without losing the volume and surface area, as well as allowing for the packaging with a quick recovery of the blend volume. One example of this packaging would be baling. Use of voluminous staple fibers allows for the blend to be packaged using traditional baling equipment and methods. This would not be possible without the voluminous fibers as the resulting package would have little to no compression recovery without additional processing after opening the package.

Depending on the web formation the porosity of the fiber web can be high or low. Generally, higher porosity facilitates the sorption of chemicals into the fibrous network—penetration into the pores. In addition, the viscosity of the liquid can impact how easily it is absorbed. For example, it is more difficult to get a more viscous liquid hydrocarbon into the small pores of a nanofiber network, but the corresponding retention would be higher. Nanofiber webs of this invention tend of have higher porosities compared to other nanofiber processes. In addition the porosities can be higher than typical meltblowing processes. This is due to a lower ratio of air mass to polymer mass in the fiber production and web forming process. In the process used in this invention, the entrained air allows entanglement and roping of the nanofibers to increase loft and porosity in the web, while maintaining small included pores.

Although the nanofiber mat has high retention properties, the compressible nature of the web allows for efficient removal of the absorbed chemicals. Moreover, the higher sorbency (i.e. 40-60 times its weight vs 10-20 using meltblown microfibers) allows the recovery of much more chemical. This could be done by running the saturated web through a nip roll, a vacuum suction, or similar process. While the efficiency of the absorption rate will likely go down following such a process due to some compression of the nanofiber web while removing the chemicals, it is expected that the nanofiber mat can be reused to absorb additional chemical material. Additionally the high surface area of the nanofibers and the method of manufacture allow the addition of a support scrim structure to the absorbent mat. Scrims may be used of the same or different materials, often including materials made with very open mesh or weave structures of very high tensile fibers. These scrims can be constructed to provide support in the machine, cross machine, and diagonal directions in relation to the porous web.

The nanofibers of the nonwoven 200 may be made in any manner able to produce thermoplastic nanofibers. One method to produce suitable nanofibers is melt-film fibrillation. Melt-film fibrillation is a high throughput process that extrudes a film or film tube which is fibrillated into small fibers via a high velocity gas. Near the exit of the slot or nozzle, high velocity gas shears the film against the tube or slot wall and fibrillates the polymer. By tuning the polymer flow, gas velocities, and nozzle geometry, the process can be used to create uniform fibers with diameters down to less than 500 nanometers in diameter, or even less than about 300 nm.

Two technologies using fibrillation have been developed which both utilize a round coaxial nozzle concept. The first is nanofibers by gas jet disclosed in several patents (U.S. Pat. No. 6,382,526, U.S. Pat. No. 6,520,425, and U.S. Pat. No. 6,695,992 all of which are incorporated by reference). The first technology uses a coaxial design, which also can include multiple coaxial tubes to add a surrounding “lip-cleaning” air, as well as multiple film tubes and multiple air streams.

The second technology utilizes an array of nozzles using a melt-film fibrillation process, disclosed in several patents (U.S. Pat. No. 6,183,670 and U.S. Pat. No. 6,315,806 all of which are incorporated by reference). This technology uses round coaxial nozzles with a central air stream and an outer film tube. Molten polymer is fed into an array of these round nozzles with polymer melt and causing some nozzles to produce fine fiber (below 1 micron in diameter) and some to produce larger fiber (greater that 1 micron in diameter).

Additionally, there is a variation on the technologies that use a film or slot form (U.S. Pat. No. 6,695,992). Conceptually, the process is an opened or “infinite” version of the film tube. The molten polymer is fed through one or more slots and has fibrillating gas streams and “lip-cleaning” streams essentially parallel to the film slot. A film sheet can then be extruded through a slot with a gas stream shearing the film against the lip and fibrillating the sheet into fine fibers.

Several other processes exist for making thermoplastic fibers with diameters below 1 micron. These processes include several of interest for this invention, including “electro-spinning”, “electro-blowing”, “melt-blowing”, “melt-film fibrillation”, “nanofiber by gas jet”, “melt fiber bursting”, “spinning melt” and “bicomponent” fibers (e.g. islands-in-sea, segmented pie). While these processes all produce fibers with submicron diameters, various fiber parameters may be unique to a particular process, such as processible materials, maximum throughput, average diameter and distribution, and fiber length. The nanofibers produced may be further processed into yarns, ropes, tapes, knits, woven or nonwoven fabric constructions. All of these fabric constructions have applications as chemical sorbents.

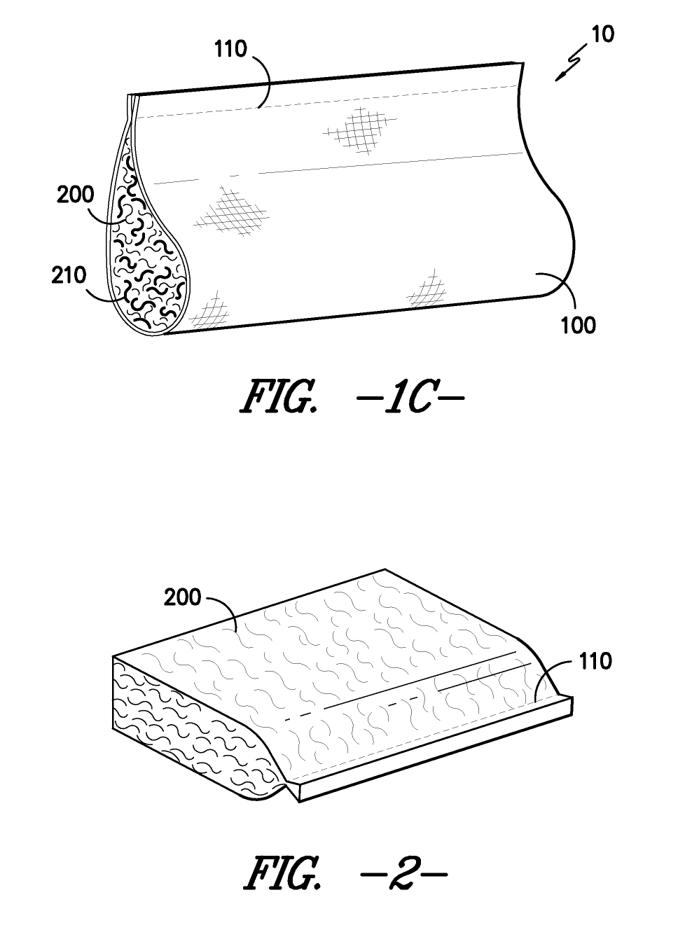

In some embodiments, there is a need for structural integrity for the nonwoven 200. In other embodiments, the nonwoven 200 may be applied directly to the spill without any need for any reinforcements or minimal reinforcements. FIG. 2 shows the nonwoven 200 with a stitch 110 giving some stability to the absorption article 11. Although a stitch is shown in FIG. 2, any method may be used to give the nonwoven 200 internal stability such as ultrasonic welding or hot embossing or lamination.

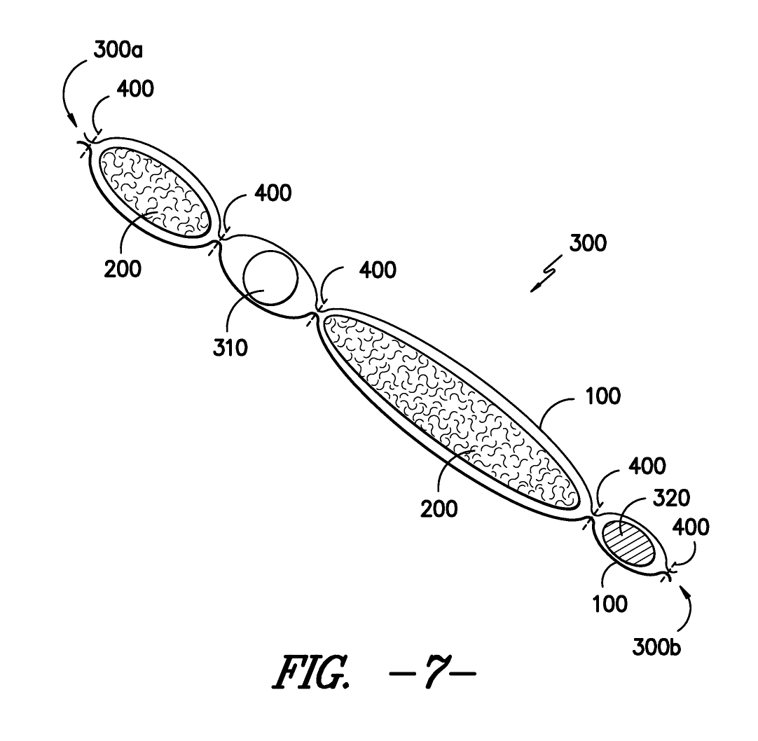

In the embodiments where a textile 100 is used in the sorbent article, the textile may be of any suitable construction and composition. The textile is preferably made out of a yarn or material that is minimally or non-soluble in the chemical to be absorbed and the environment of the spill (for example water and oil in the case of a crude oil spill in the ocean). Further the composition and construction are selected to give the desired tensile, abrasion, and ductile characteristics. For a small article as shown in FIG. 6, the tensile strength may not be as important as when the article is a tube (FIG. 5) that may be several thousand feet long and will be wound and unwound. In one embodiment, the tensile strength of the textile 100 is at least about 10 lbs/inch, more preferably at least about 40 lbs/inch. The textile may be a laid scrim, spunbond, woven, nonwoven, knit, or any other textile. Preferably, the textile is an open construction to allow for the chemical to easily pass through the textile to reach the nonwoven 200. The yarn forming the textile 200 may be any of the polymers listed for use as possible nanofibers as well as any other thermoplastic or thermoset fiber, natural or synthetic fiber.

The porosity of the textile 100 may be tailored to the oil absorption application. In one embodiment, a layer of nanofibers is applied to the inner surface of the textile 100 to control porosity and reduce oil leakage out of the article 10. The nanofiber layer may be applied to any textile layer 100 such as, but not limited to, woven, nonwoven, spunbond, scrim, and knit. A film membrane with controlled porosity like a polytetrafluoroethylene (PTFE) membrane can also be laminated onto the inside of textile 100 to reduce oil leakage. In addition, the two sides of the membrane can be functionalized so as to achieve preferential one-way transport of oil from the outside to inside (oleophilic outside, oleophobic inside). One additional benefit of using these textiles to encapsulate the nanofiber mat is that it can act as a method to insure the nanofibers themselves are not released to the environment being cleaned.

In one embodiment, the sides of the textile forming the outside of the article 10 may have different porosities. In a preferred embodiment, when the article 10 is a boom for picking up oil, the top portion of the textile of the article have a higher porosity then the textile on the bottom section of the article. In one embodiment, the bottom section may have little to no porosity to the environment and chemical to be absorbed. This may function like a cup collecting an amount of the chemical spill and keeping it from releasing back into the environment.

In one embodiment, the textile may contain some or all high tenacity yarns or fibers. These high modulus fibers may be any suitable fiber having a modulus of at least about 4 GPa, more preferably greater than at least 15 GPa, more preferably greater than at least 70 GPa. Some examples of suitable fibers include glass fibers, aramid fibers, and highly oriented polypropylene fibers as described in U.S. Pat. No. 7,300,691 by Eleazer et al. (herein incorporated by reference), bast fibers, and carbon fibers. A non-inclusive listing of suitable fibers for the high modulus fibers 110 of the first layer 100 include, fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON® fibers from ITS of Charlotte, N.C.). Suitable fibers also include those made from rigid-rod polymers, such as lyotropic rigid-rod polymers, heterocyclic rigid-rod polymers, and thermotropic liquid-crystalline polymers. Suitable fibers made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable fibers made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxy)phenylene] fibers (PIPD fibers) (e.g., M5® fibers from DuPont of Wilmington, Del.). Suitable fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable fibers also include boron fibers, silicon carbide fibers, alumina fibers, glass fibers, carbon fibers, such as those made from the high temperature pyrolysis of rayon, polyacrylonitrile (e.g., OFF® fibers from Dow of Midland, Mich.), and mesomorphic hydrocarbon tar (e.g., THORNEL® fibers from Cytec of Greenville, S.C.).

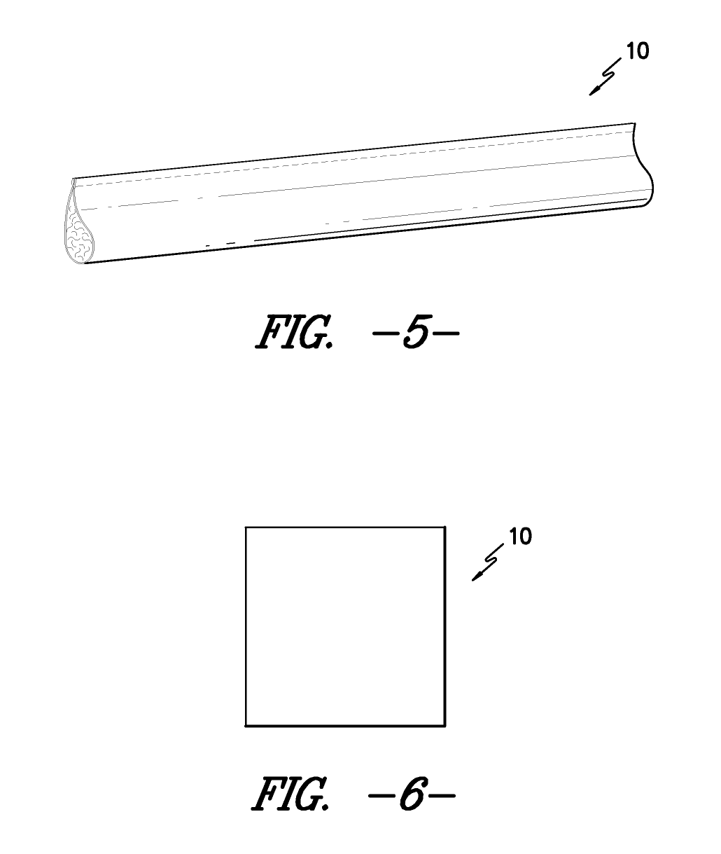

In one embodiment, the textile is folded to form a tear drop shape. As shown in FIGS. 1A, 1B, 3, and 4. The absorbent article has at least one strip-shaped panel of textile folded onto itself in the longitudinal direction to form a flexible structure and it is attached proximate to its respective longitudinal edges to define a longitudinal channel. This channel is filled with a nanofiber nonwoven or clusters of loose nanofibers before attaching the longitudinal edges or after. Articles used as innerduct structures to bring cables through conduit may have value as the textile part of the absorbent article 10 with few if any changes.

In further embodiment, more than one textile may be folded and connected along the longitudinal edges to form multiple tear drop shapes or lobes. Having multiple lobes, as little as 2 or 3 or as many as 6, 8, or more, increases the surface area of the absorbent article and may increase the speed at which the article takes up spilled chemicals or the total amount of spilled chemicals absorbed. The individual lobes can be of different shapes and sizes and can be preferentially offset from each other in the fabric construction. More information about these constructions may be found in U.S. Pat. No. 6,304,698 and US 2008/0264669 both of which are incorporated by reference. This provides a compact delivery method for sorbent materials to the site of the chemical spill. Another delivery method for sorbent yarns, tapes, ropes, knits, woven or nonwoven involves wrapping them around a buoyant structure such as a tube or foam.

Typical constructions and packaging for oil sorbent products may be utilized with this invention. These include, but are not limited to forming the nanofibers into nonwoven rolls, pads, or mats and forming pillows, socks, ropes, or various boom constructions commonly used for meltblown fibers and other fiber and loose-fill sorbent products. Reinforcing scrims, webs, fabrics, socks, and tubes common for packaging the fibers into various boom, pillow, and sock constructions may be used.

In addition, constructions incorporating either boom segments or continuous booms and ropes, may incorporate additional components to enhance tensile strength, control buoyancy, and facilitate reeling the product in and out of vessels or other carriers. For example, weights can be attached into the casing by sewing, stitching, adhesive, crimping, or otherwise attaching to control the portion of the boom above and below the water surface. Likewise, additional tensile members may be incorporated, for example, to facilitate strength requirements to reel in long lengths of saturated boom materials.

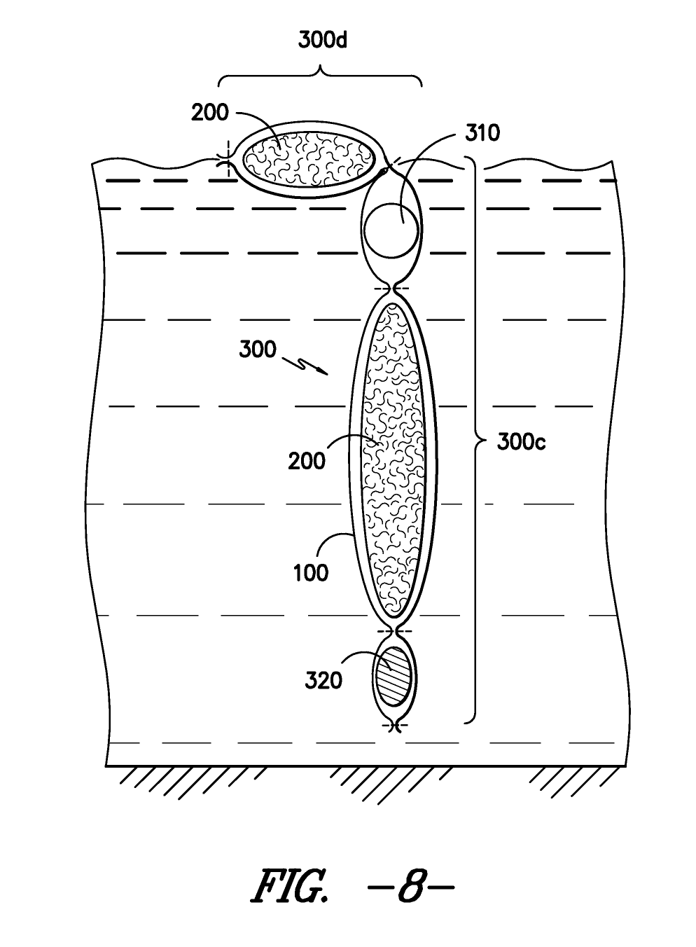

In one embodiment, the chemical spill absorption article is a boom fence 300, preferably for absorbing oil. An illustration of a cross-section of the fence 300 is shown in FIG. 7. The fence is designed with weights 320, nonwovens 200, and a buoyant article 310 to position it in the water. The fence 300 shown in FIG. 7 would extend down into the water with the weighted end 300b submerged in the water and the buoyant end 300a sticking up out the water. This configuration serves to protect areas such as coast lines from oil spills. The fence preferably has a weight 320 sewn into the fence 300. The weight 320 may be attached by any other means available including crimping, adhesive, or encapsulating it in a pocket of the fabric 100 of the fence. In the embodiment shown in FIG. 7, the fence 300 contains two nonwovens 200. These nonwovens 200 are described above and may be nanofibers or a mixture of nanofibers and larger diameter fibers. While FIG. 7 is shown with two nonwovens 200, the fence 300 may have any number of nonwovens from one to ten and beyond. The nonwoven may also extend from edge to edge of the fence, or be discontinuous as shown in FIG. 7. The buoyancy article 310 works in conjunction with the weights 320 to position the fence relative to the water. The buoyancy article may be made out of any material that has a lower density than the fluid it resides in. For example, the buoyancy article 310 may be a voided or closed-cell foamed polyethylene in a sheet or tubular form. A tubular foamed polyethylene is sold today as “noodle” pool toys. The fence is enclosed at both ends 300a and 300b. While FIG. 7 illustrates an embodiment where there are two layers of fabric 100 joined together, one piece of fabric could be folded over itself (similar to FIGS. 1A-1C). In addition, other stitching 400 may be used along the length or width of the fence 300 to keep the weights 320, nonwoven 200, and buoyant article 310 in the proper place and prevent any of the materials from bunching up. The stitching 400 may also include quilting. While the fence 300 is shown as one piece in FIG. 7, it is contemplated that the fence may be formed of individual sections (such as a buoyancy article, weights, etc) attached together by sewing, adhesive, or any other means to form the fence.

FIG. 8 illustrates how a fence 300 may be set up in an ocean based chemical spill such as oil. The lower fence section 300c (approximately from the buoyancy article 310 to the weight 320) is submerged in the water. This prevents oil from being pushed under the fence 300 by the waves and current. The upper fence section 300d either sticks out of the water or lies on the surface of the water as shown in FIG. 8. The upper section 300d would absorb oil on the surface of the water and the length of the 300d section would prevent waves from moving the oil over the fence 300. The lower section 300c may be tailored to optimize the water flow through the section. In one embodiment, it is desired to have a higher flow of water through the fence (as this would allow the waves and current to pass through the fence and not push it around in the water as much. Some ways to increase the water flow through the lower section 100c of the fence include making the fabric thinner or more porous, placing a greater percentage of larger diameter (greater than 1 micron) staple fibers, making the nonwoven less dense or thinner. One other method for increasing flow through the lower section 100c of the fence includes making some of the fibers in the nonwoven 200 in the lower section 100c hydrophilic. This may be done by having the nonwoven have non-treated nanofibers and hydrophilic treated micron-sized fibers, a percentage of nanofibers that are treated, or treated nanofibers and non-treated micron-sized fibers. Having the hydrophilic fibers allows water to more easily penetrate the fence and thus allows for greater water flow where the non-treated fibers can “filter” and absorb the oil.

It would be desirable to reclaim the oil from the sorbent material as well as reuse the sorbent. Processes using press rolls or vacuum suction can be used to remove the oil from the fibrous sorbent. One preferred embodiment to do this includes wrapping nanofiber yarns, tapes, ropes, knits, woven or nonwoven constructions around a porous mandrel or tube, and further applying suction to reclaim the oil through the mandrel or tube after chemical absorption. Another preferred embodiment to reclaim the oil includes laminating or wrapping nanofiber yarns, tapes, ropes, knits, woven or nonwoven on a highly porous textile such as high-loft air laid nonwovens, spacer fabrics or reticulated foams. It is also noted that by incorporating the voluminous staple fibers with crimp and the like, as detailed earlier, the porous structure of the web and ability to absorb additional materials after this reclamation will be greatly enhanced.

While the chemical sorbent article may be tailored to absorbing chemical spills, it may also absorb other chemicals such as facial oils. In one embodiment, the sorbent article is a facial wipe that absorbs facial oils from users. The non-woven on the sorbent article is preferably surrounded only partially (preferably on one side) by the textile.

### EXAMPLES

### Examples 1-4

Description of process—The die used to make continuous thermoplastic nanofibers is a research scale 2″ slot. The die distributes polymer from the melt pump to a 10 mil film channel that is 2 inches wide. The film is extruded onto a short lip (0 to 125 mils long, or more preferably 50-60 mils long) where it is sheared thin and fibrillated by a high velocity air stream. The air stream is fed through an adjustable air slot (generally set between 1-10 mil, or about 5 mil, at its exit), impeding on the lip at about a 30 degree angle. The air exits and expands at the slot lip where it shears, fibrillates, and carries the polymer as fine fibers into an air stream. The fibers are collected as a randomized non-woven mat on a collection drum, where the distance between the exit of the die and the collection drum can be adjustable. Air pressures between 20-80 psi are typical, with air flows through the 2″ wide slot ranging between 2-10 cfm. The air can be fed at room temperature or heated, and is typically heated between 500 and 600° F. The die is likewise heated to maintain the polymer in a molten state.

Resin—Continuous sub-micron fibers were made from an ultra-high melt flow rate polypropylene (PP) homopolymer, with a very narrow molecular weight distribution (Metallocene-based Achieve™ 6936G1, from ExxonMobil Chemical USA, MFR=1550 gram/10 min, measured using ASTM D1238). The melting point of Achieve™ 6939G1 PP is Tm=158° C.

Process conditions—An extruder (0.75″, single-screw extruder, 5-6 lbs/hr) with a gear pump was used to deliver the polymer melt to the slot die through a supply hose. The gear pump was set to a constant set-point of 30, and this produced a melt feed-rate of about 19.85 gram/min. The extruder temperature was 540° F. and the temperature of the polymer melt in the supply hose was 560° F. The slot die was heated to 575° F. using cartridge heaters. A source of pressurized air was fed from an air supply line to the inlet of the die via air-tight connectors, and the volume of compressed air entering the die was recorded using a flow meter. The pressurized air was introduced at 2.5 cfm (cubic feet per minute) at 40 psi and at an air temperature of 600° F. Non-woven webs with a basis weight of 150 gram/m² were collected on a collection drum that was held in place 6 inches (Example 1), 12 inches (Example 2), 24 inches (Example 3) and 36 inches (Example 4) from the exit of the die. Increasing the collection distance resulted in a nonwoven web with higher loft (thickness, lower density). The presence of a nucleating agent (Millad 3988 or NX8000, Milliken & Company) in the polymeric material forming the fibers enhances the rate of crystallization, thereby solidifying the fibers formed using the process described above significantly faster than the fibers formed from the polymer without a nucleator (not used in these examples). This rapid solidification allows the fibers to be individually dispersed in the air stream and be collected as a high-loft nonwoven mat on the collector (fiber-fiber bonding and entanglement is minimized). The fiber size distributions were measured from scanning electron microscopy (SEM) images and were determined to be in the range of 100 nm to 1.15 μm, with an average diameter of 228 nm and a standard deviation of 56 nm.

### Examples 5-6

Resin—Continuous sub-micron fibers were made from a crystallized polyester (PET) homopolymer (Eastman F53HC, from Eastman Chemical Company USA, Intrinsic Viscosity=0.53).

Process conditions—An extruder (0.75″, single-screw extruder, 5-6 lbs/hr) with a gear pump was used to deliver the polymer melt to the slot die through a supply hose. The gear pump was set to a constant set-point of 30, and this produced a melt feed-rate of about 32.56 gram/min. The extruder temperature was 540° F. and the temperature of the polymer melt in the supply hose was 560° F. The slot die was heated to 575° F. using cartridge heaters. A source of pressurized air was fed from an air supply line to the inlet of the die via air-tight connectors, and the volume of compressed air entering the die was recorded using a flow meter. The pressurized air was introduced at 2.5 cfm (cubic feet per minute) at 40 psi and at an air temperature of 600° F. Non-woven webs with a basis weight of 150 gram/m² were collected on a collection drum that was held in place 6 inches (Example 5) and 24 inches (Example 6) from the exit of the die.

### Example 7

Example 7 was a commercially available polypropylene meltblown sorbent pad available from McMaster-Carr (Product number: 7516T48). The sample was designed to absorb oil. This commercial meltblown product was used as a comparative example.

### Testing

Sorbency measurements—One method of measuring absorbent performance of non-woven mats is by calculating the sorbency ratio. This is defined as the ratio of the liquid weight absorbed and the dry absorbent weight.

Sorbency=(wet weight−dry weight)/dry weight

The sorbency ratio and the absorption kinetics depend on a variety of factors—ambient temperature, polarity of the liquid, surface tension and viscosity of the liquid. The nanofiber sorbents described in Examples 1-6 are suitable for absorbing a wide range of liquids. To test the absorbency of the nanofiber mats with major chemical groups, we used a representative set from the list of chemicals compiled by 3M as an indication of absorbency (see Table 1). All measurements were performed at room temperature (23° C.). Fresh sorbent samples were cut into the size of 4 inches×4 inches from the nonwoven mats made in Examples 1-6. The samples were then weighed and placed in a test cell containing the chemical to be absorbed for 5 minutes. The excess chemical was allowed to drip from the sample, and the wet weight of the sorbent was recorded. The absorption kinetics (how fast the sample absorbed the chemical) and the retention capacity (how well the sorbent was able to hold the chemical) after the test were also monitored.

TABLE 1
Chemical sorbency of Examples 1-6

| | Sorbency | | | | | | |
|---|---|---|---|---|---|---|---|
| Chemical | Ex. 1 | Ex. 2 | Ex. 3 | Ex. 4 | Ex. 5 | Ex. 6 | Ex. 7 |
| Acids | | | | | | | |
| Acetic acid | 15.90 | 20.84 | 23.61 | 26.86 | 12.38 | 14.98 | — |
| Phosphoric acid | 3.91 | 4.13 | 4.28 | 5.62 | 18.83 | 39.66 | — |
| 85% | | | | | | | |
| Hydrocarbons/ | | | | | | | |
| Oils | | | | | | | |
| Mineral oil | 15.33 | 21.64 | 26.71 | 32.24 | 16.67 | 41.91 | 12.27 |
| Vegetable oil | | | 57.43 | | | | 13.11 |
| Ketones | | | | | | | |
| Acetone | 10.68 | 14.95 | 18.33 | 22.20 | 8.35 | 14.66 | — |
| Alcohols | | | | | | | |
| Ethanol | 12.35 | 15.97 | 19.60 | 22.73 | 11.12 | 19.02 | — |
| Alkalis | | | | | | | |
| NaOH (7M) | 1.25 | 0.93 | 1.71 | 2.94 | 3.18 | 7.64 | — |
| Aromatic | | | | | | | |
| Toluene | 12.43 | 15.13 | 21.21 | 21.32 | 10.43 | 21.9 | — |
| Glycols | | | | | | | |
| Polyethylene | 19.67 | 27.19 | 33.82 | 29.91 | 15.92 | 37.12 | 3.43 |
| glycol 400 | | | | | | | |
| Others | | | | | | | |
| Water | 0.9 | 1.25 | 1.54 | 1.72 | 1.5 | 6.18 | — |

It can be seen from Table 1 that the chemical sorbency increased with the loft (thickness) of the sorbent tested (Example 4 had a higher sorbency than Example 1, Example 6>Example 5). Also, fibrous polypropylene and polyester sorbent media have an affinity for oil and are hydrophobic (polypropylene is more hydrophobic than polyester). Further, the nanofiber samples Examples 1-6 far out performed the micron sized fiber sample of Example 7. The invention examples 1-6 will soak up oil without absorbing water and can be used to effectively clean up oil spills on water. The sorbency of these fibrous mats to water can be enhanced by treating the fibers with a surfactant to make it more wettable or by the use of blooming additives in the polymer melt (Irgasurf from Ciba for polypropylene). The chemical absorbed can be reclaimed by running the sorbent material through a nip or a vacuum slot, allowing the sorbent to be re-used. Loss of loft or densification during the reclamation process can compromise its absorption capacity.

### Example 8

For oil spill clean-up applications, compact delivery of the sorbent material is important for efficient absorption and material handling. Flexible textiles made by Milliken & Company for use in MaxCell® innerducts for the network construction industry can be used as a reinforced carrier of the sorbent materials made in Examples 1-6. Textiles of the variety used in the MaxCell innerducts are woven substrates comprising monofilament PET/Nylon yarns that can be shaped into a multi-lobal arrangement held together by a threaded seam. Each lobe in the MaxCell innerduct textile can be filled with fibrous sorbent material. The open pores in the substrate allow the oil film to be accessed by the sorbent, and the monofilament yarns provide the required mechanical properties needed to handle the sorbent material after oil absorption. The number of lobes (maximize surface area available for absorption) in the textile and the weave construction can be changed according to requirements. A 300 gram/m² polypropylene nanofiber web (30″×48″) made using the process described earlier on a MaxCell innerduct woven substrate (monofilament PET/Nylon), rolled and stitched along the edges is shown schematically in FIG. 5.

### Example 9-10

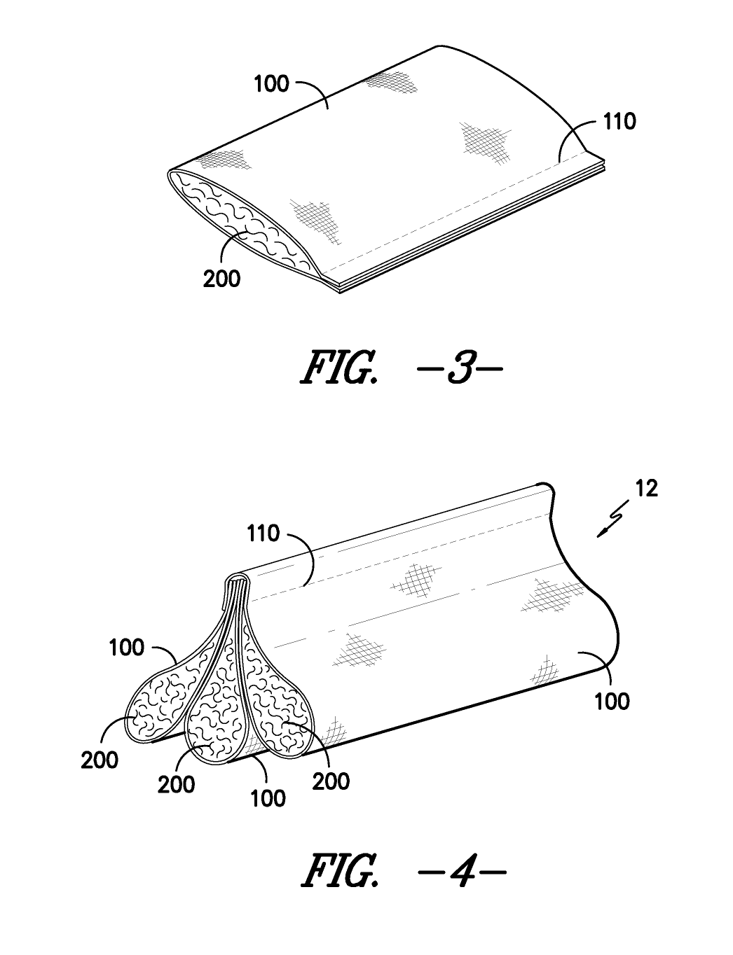

The fibrous sorbent material needs to be reinforced to provide adequate mechanical properties for material handling. These examples provide two preferred ways to do that—a) spunbond scrims (Example 8) and b) Weft insertion, warp knit (WIWK) or chemically bonded nonwoven laid scrims. These reinforcing scrims in these examples were made of PET. However, other fibers can be used to construct the scrims depending on the application. A 300 gram/m² PP nanofiber sorbent (30″×48″) positioned on a PET spunbond and a WIWK textile, folded along the longer dimension and stitched along the edges is shown schematically in FIG. 3. The scrims can also be laminated to the sorbent material using a low melt web adhesive. The scrim is designed to not adversely affect the sorbency of the fibrous sorbent material significantly.

### Examples 11-13

Description of process to make nanofibers—The die used to make continuous thermoplastic sub-micron fibers is a research scale 2″ slot. The die distributes polymer from the melt pump to a 10 mil film channel that is 2 inches wide. The film is extruded onto a short lip (0 to 125 mils long, or more preferably 50-60 mils long) where it is sheared thin and fibrillated by a high velocity air stream. The air stream is fed through an adjustable air slot (generally set between 1-10 mil, or about 5 mil, at its exit), impeding on the lip at about a 30 degree angle. The air exits and expands at the slot lip where it shears, fibrillates, and carries the polymer as fine fibers into an air stream. The fibers are collected as a randomized non-woven mat on a collection drum, where the distance between the exit of the die and the collection drum can be adjustable. Air pressures between 20-80 psi are typical, with air flows through the 2″ wide slot ranging between 2-10 cfm. The air can be fed at room temperature or heated, and is typically heated between 500 and 600° F. The die is likewise heated to maintain the polymer in a molten state.

Resin used to make nanofibers—Continuous sub-micron fibers were made from an ultra-high melt flow rate polypropylene (PP) homopolymer, with a very narrow molecular weight distribution (Metallocene-based Achieve™ 6936G1, from ExxonMobil Chemical USA, MFR=1550 gram/10 min, measured using ASTM D1238). The melting point of Achieve™ 6939G1 PP is Tm=158° C.

Process conditions used to make nanofibers—An extruder (0.75″, single-screw extruder, 5-6 lbs/hr) with a gear pump was used to deliver the polymer melt to the slot die through a supply hose. The gear pump was set to a constant set-point of 30, and this produced a melt feed-rate of about 60 gram/min. The extruder temperature was 600° F. and the temperature of the polymer melt in the supply hose was 610° F. The slot die was heated to 630° F. using cartridge heaters. A source of pressurized air was fed from an air supply line to the inlet of the die via air-tight connectors, and the volume of compressed air entering the die was recorded using a flow meter. The pressurized air was introduced at 2.5 cfm (cubic feet per minute) at 40 psi and at an air temperature of 630° F. Non-woven fiber mats and loose fibers were collected 60 inches from the exit of the die. Increasing the collection distance resulted in a nonwoven web with higher loft (thickness, lower density). The presence of a nucleating agent (Millad 3988 or NX8000, Milliken & Company) in the polymeric material forming the fibers enhances the rate of crystallization, thereby solidifying the fibers formed using the process described above significantly faster than the fibers formed from the polymer without a nucleator. This rapid solidification allows the fibers to be individually dispersed in the air stream and be collected as a high-loft nonwoven mat on the collector (fiber-fiber bonding and entanglement is minimized). The fiber size distributions were measured from scanning electron microscopy (SEM) images and were determined to be in the range of 100 nm to 1.15 μm, with an average diameter of 228 nm and a standard deviation of 56 nm.

A 3.3″ diameter, 10 inch long oil sorbent boom was made using a polyester (PET) spunbond substrate. The boom was filled with 25 grams (Example 11), 50 grams (Example 12) and 75 grams (Example 13) of polypropylene nanofibers made using the process described above. The different fiber packing ratios affect the kinetics of oil absorption, the amount of oil absorbed and the wicking rate. Assuming the boom does not expand or swell, the absorption capacity of the fibrous sorbent is limited by the physical volume of the boom.

### Examples 14-16

Meltblown fibers are used extensively for environmental marine oil spill clean up. Meltblowing is a process of making fibrous webs, wherein high velocity air blows a molten thermoplastic polymer through a series of holes at the die tip onto a conveyor or take up screen to form a nonwoven web comprising 2-10 μm diameter fibers. In order to save cost, scrap waste generated during the meltblowing process is sent through a chopper gun to make short fibers that can then be used to fill booms for oil absorption. Fibers from an oil-only polypropylene sorbent boom commercially available from McMaster-Carr (Product number: 7516T23) was used as a representative meltblown fiber sample. The purchased boom was 5″ in diameter and 120″ long and had an absorption capacity of 8 gallons.

A 3.3″ diameter, 10 inch long oil sorbent boom was made using a polyester (PET) spunbond substrate. The boom was filled with 25 grams (Example 14), 50 grams (Example 15) and 75 grams (Example 16) of polypropylene meltblown fibers.

### Examples 17-18

Staple fibers are traditionally used to make spun yarns or carded into nonwoven webs. The process used to make staple fibers consists of the following steps—Extrusion or spinning, drawing, crimping and packaging. Polypropylene staple fibers are usually between 15 and 40 μm in diameter and several inches long. A 3.3″ diameter, 10 inch long oil sorbent boom was made using a polyester (PET) spunbond substrate. The boom was filled with 25 grams (Example 17) of 1.7 dtex (15 μm diameter) polypropylene fiber (Asota® FV10DP) with a staple length of 40 mm.

Staple fibers in the form of “fiber clusters” or “fiber balls” as described in U.S. Pat. No. 6,613,431 can also be used as oil sorbents. The patent describes a modified carding machine that mechanically twists and entangles polyester fibers into fiber balls. A 3.3″ diameter, 10 inch long oil sorbent boom was made using a polyester (PET) spunbond substrate. The boom was filled with 25 grams (Example 18) of PET fiber clusters made using a 7 denier PET staple fiber.

### Examples 19-21

A combination of fibers of different types and sizes can be used to optimize the balance between oil absorption and retention. The blend of fibers can also be tailored to achieve a desired rate of oil wicking into the fibrous sorbent. When a recycled waste stream of staple fibers (carpet waste) or meltblown fibers (waste from pads or wipes) are available, it can be blended with nanofibers to maximize oil absorption and minimize boom cost. A 3.3″ diameter, 10 inch long oil sorbent boom was made using a polyester (PET) spunbond substrate. In Example 19, the boom was filled with 25 grams each of the polypropylene nanofibers and meltblown fibers described earlier. In Example 20, the boom was filled with 25 grams each of the polypropylene nanofibers and staple fibers (1.7 dtex) described earlier. In Example 21, the boom was filled with 12.5 grams of polypropylene nanofibers and 12.5 grams of PET fiber clusters described earlier.

### Testing

Boom sorbency measurements—One method of measuring absorbent performance of oil booms is by calculating the sorbency ratio. This is defined as the ratio of the oil weight absorbed and the dry absorbent weight.

Sorbency=(wet weight−dry weight)/dry weight

All measurements were performed at room temperature (23° C.). The boom samples made in Examples 11-21 were weighed and placed in a test cell containing motor oil (SAE 10W-30) for 30 minutes. The excess oil was allowed to drip from the sample for 1 minute, and the wet weight of the sorbent boom was recorded. The boom was then placed on a spunbond-meltblow-spunbond (SMS) laminate pad to absorb excess oil leaking out of the boom. When no more oil was seen leaking out, the weight of the boom was recorded to calculate the amount of oil retained in the fibrous sorbent inside the boom. The absorption kinetics (how fast the sample absorbed the chemical) was also monitored during the test.

TABLE 2
Oil sorbency of Examples 11-21

| | | Weight of | Weight of oil | | Weight of | |
|---|---|---|---|---|---|---|
| | | fiber in | absorbed | Sorbency | oil retained | |
| | Type of | the boom | after 30 min. | after 30 | in boom | Actual |
| Sample | fiber | (grams) | (grams) | min. | (grams) | Sorbency |
| Ex. 11 | Nanofiber | 25 | 613.98 | 24.55 | 388.58 | 13.05 |
| Ex. 12 | Nanofiber | 50 | 860.62 | 17.21 | 670.73 | 13.41 |
| Ex. 13 | Nanofiber | 75 | 855.23 | 11.40 | 824.09 | 10.98 |
| Ex. 14 | Meltblown | 25 | 362.26 | 14.29 | 212.26 | 7.08 |
| Ex. 15 | Meltblown | 50 | 624.41 | 12.48 | — | — |
| Ex. 16 | Meltblown | 75 | 754.85 | 10.06 | 514.45 | 6.85 |
| Ex. 17 | Staple | 25 | 469.9 | 18.79 | 285.33 | 9.52 |
| | fiber | | | | | |
| Ex. 18 | Fiber | 25 | 761.65 | 30.46 | 118.37 | 3.94 |
| | cluster | | | | | |
| Ex. 19 | Nanofibers + | 50 | 691.92 | 13.63 | 466.43 | 9.32 |
| | Meltblown | | | | | |
| Ex. 20 | Nanofibers + | 50 | 889.17 | 17.78 | 556.46 | 11.12 |
| | Staple | | | | | |
| | fiber | | | | | |
| Ex. 21 | Nanofibers + | 25 | 700.09 | 28.00 | 277.63 | 9.25 |
| | Fiber | | | | | |
| | clusters | | | | | |

It can be seen from Table 2 that the type of fiber and the fiber packing ratio used in the boom influences the amount of oil absorbed after 30 minutes and the amount of oil retained. In general, the amount of oil absorbed and retained by nanofibers is greater than that of meltblown fibers and staple fibers. Interestingly, the initial sorbency of PET fiber clusters (Example 18) is greater than that of nanofibers (Example 11). However, the boom containing fiber clusters has poor retention and loses almost 6 times the oil weight absorbed a few minutes after it is removed from the test cell. The sorbency of the nanofibers and meltblown samples decreases with increased fiber packing density inside the boom. The amount of oil absorbed approaches the maximum volume of oil that can be absorbed by the boom as the packing density is increased (unless the boom is allowed to significantly expand, the fibers cannot absorb any more oil). The percent retention in sorbency is also greater at higher packing densities.

It is possible to optimize the balance between oil absorption, retention and wicking speeds by using a blend of fibers. It can be seen from Table 2 that the oil retention of booms containing meltblown fibers, staple fibers or fiber clusters can be significantly improved by blending with nanofibers. It was also observed that the wicking rate of oil into nanofiber booms can be improved by blending with meltblown fibers or staple fibers. Also, blending recycled waste fiber streams with high oil absorption capacity nanofibers allows us to engineer high efficiency oil booms at lower cost.

### Example 22

It can be seen from Table 2 that the oil booms can have a problem with retention over an extended period of time. The booms in Examples 11-21 were made using a porous PET spunbond that allowed excess oil, not absorbed by the sorbent after 30 minutes, to leak out of the boom. One way to minimize the loss of oil would be to line the inside of the spunbond with a fibrous or film membrane of controlled porosity (pore size smaller than the spunbond). In addition, the two sides of the membrane can be functionalized so as to achieve preferential one-way transport of oil from the outside to inside (oleophilic outside, oleophobic inside).

A 3.3″ diameter, 10 inch long oil sorbent boom was made using a polyester (PET) spunbond substrate coated with a 30 gram/m² PET membrane on the inside. The boom was filled with 25 grams each of the polypropylene nanofibers described earlier.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A chemical sorbent article comprising:
a nonwoven comprising a plurality of thermoplastic nanofibers; and,
a textile, wherein the textile at least partially surrounds the non-woven.

2. The chemical sorbent article of claim 1, wherein the thermoplastic nanofibers comprise polypropylene.

3. The chemical sorbent article of claim 1, wherein the thermoplastic nanofibers comprise polyolefin.

4. The chemical sorbent article of claim 1, wherein the nonwoven has a density less than about 0.2 gram/cc.

5. The chemical sorbent article of claim 1, wherein the textile is selected from the group consisting of a laid scrim, spunbond, woven textile, knit textile, or nonwoven textile.

6. The chemical sorbent article of claim 1, wherein the textile comprises at least one strip-shaped panel of textile folded onto itself in the longitudinal direction and attached proximate to its respective longitudinal edges to define a longitudinal channel and wherein the nonwoven is inside the longitudinal channel.

7. The chemical sorbent article of claim 6, wherein the textile comprises at least two strip-shaped panels of textile folded onto themselves in the longitudinal direction and attached proximate to their respective longitudinal edges to define two longitudinal channels and wherein the nonwoven is inside each of the longitudinal channels.

8. The chemical sorbent article of claim 1, wherein the nonwoven further comprises a plurality of thermoplastic micron-sized fibers.

9. The chemical sorbent article of claim 1, wherein the textile further comprises a coating of nanofibers on at least one side of the textile.

10. The chemical sorbent article of claim 1, wherein the sorbent article is a facial wipe and the chemical to be absorbed is facial oil.

11. A chemical sorbent article comprising:
a nanofiber article selected from the group consisting of yarns, tapes, ropes, knits, woven and nonwoven, wherein the nanofiber article comprises nanofibers; and,
a buoyant structure, wherein the nanofiber article at least partially surrounds the buoyant structure.

12. The chemical sorbent article of claim 11, wherein the nanofibers comprise polypropylene.

13. The chemical sorbent article of claim 11, wherein the nanofiber article further comprises a plurality of thermoplastic micron-sized fibers.

14. An boom fence comprising:
a nonwoven comprising a plurality of thermoplastic nanofibers;
a weight;
a buoyancy article; and,
a fabric, wherein the fabric at least partially surrounds the nonwoven, the weight, and the buoyancy article, and wherein the weight and buoyancy article are separated by the nonwoven.

15. The boom fence of claim 14, wherein the thermoplastic nanofibers comprise polypropylene.

16. The boom fence of claim 14, wherein the thermoplastic nanofibers comprise polyolefin.

17. The boom fence of claim 14, wherein the nonwoven has a density less than about 0.2 gram/cc.

18. The boom fence of claim 14, wherein the fabric is selected from the group consisting of a laid scrim, spunbond, woven textile, knit textile, or nonwoven textile.

19. The boom fence of claim 14, wherein the nonwoven further comprises a plurality of thermoplastic micron-sized fibers.

20. The boom fence of claim 14 wherein the fabric comprises two layers of fabric sewn together along a first seam side and a second seam side forming a pocket and wherein the inside of the pocket contains in order from the first seam side of the layers of fabric to the second seam side of the layers of fabric;
the nonwoven comprising a plurality of thermoplastic nanofibers;
the buoyancy article;
an additional nonwoven comprising a plurality of thermoplastic nanofibers; and,
the weight.
